(19) United States
(12) Patent Application Publication
(10) Pub. No.: US 2022/0405763 A1
(43) Pub. Date: Dec. 22, 2022

(54) CUSTOMER IDENTIFICATION SERVER, CUSTOMER IDENTIFICATION SYSTEM, AND CUSTOMER IDENTIFICATION PROGRAM

(71) Applicant: TOSHIBA TEC KABUSHIKI KAISHA, Tokyo (JP)

(72) Inventor: Misako Kofuji, Sunto Shizuoka (JP)

(21) Appl. No.: 17/570,397

(22) Filed: Jan. 7, 2022

(30) Foreign Application Priority Data
Jun. 22, 2021 (JP) 2021-103008

(51) Int. Cl. G06Q 20/40; G06V 40/16; G06Q 20/20

(52) U.S. Cl. CPC G06Q 20/40145; G06V 40/172; G06V 40/171; G06Q 20/20

(57) ABSTRACT

A customer identification server includes an acquiring unit, a storing unit, and a controller. The acquiring unit acquires first customer information based on biological information acquired by biological-information acquiring means and first card information read by a card reader. The storing unit stores second card information and second customer information associated with the second card information. The controller determines whether the acquired first card information is the same as the second card information and the acquired first customer information and the second customer information are the same and, if the first card information and the first customer information are the same as the second card information and the second customer information, outputs information for permitting settlement performed using the first card information.

### CROSS-REFERENCE TO RELATED APPLICATION

This application is based upon and claims the benefit of priority from Japanese Patent Application No. 2021-103008, filed on Jun. 22, 2021, the entire contents of which are incorporated herein by reference.

### FIELD

Embodiments described herein relate generally to a customer identification server, a customer identification system, and a customer identification program.

### BACKGROUND

As cashless settlement, there has been, for example, settlement by a credit card in which personal identification such as an input of a password or a signature is basically performed. As the credit card settlement, there has been silence settlement. The silence settlement is settlement in which, between a credit card company and a store having a contract concerning the silence settlement, settlement of account equal to or smaller than a fixed amount can be performed without personal identification.

However, in such settlement in which personal identification is not performed, a user of a credit card or the like cannot be authenticated.

### DESCRIPTION OF THE DRAWINGS

FIG. 1 is a block diagram illustrating an example of a configuration example of an entire customer identification system in an embodiment;

FIG. 2 is a block diagram illustrating an example of a hardware configuration of a server in the embodiment;

FIG. 3 is a diagram illustrating an example of a data configuration of card management information stored in a storing unit in the server;

FIG. 4 is a block diagram illustrating an example of a hardware configuration of a POS in the embodiment;

FIG. 5 is a diagram illustrating an example of notification displayed by a display unit in the POS if customer information coincides;

FIG. 6 is a diagram illustrating an example of notification displayed by the display unit in the POS if customer information does not coincide;

FIG. 7 is a flowchart for explaining a flow of processing by a control unit of the POS;

FIG. 8 is a flowchart for explaining the flow of the processing; and

FIG. 9 is a flowchart for explaining a flow of customer identification processing by a control unit of the server.

### DETAILED DESCRIPTION

An aspect of embodiments is to provide, in order to solve the problems described above, a customer identification server, a customer identification system, and a customer identification program capable of performing personal identification even in cashless settlement in which the personal identification is not performed.

A customer identification server according to an embodiment includes an acquiring unit, a storing unit, and a control unit. The acquiring unit acquires first customer information based on biological information acquired by biological-information acquiring means and first card information read by a card reader. The storing unit stores second card information and second customer information associated with the second card information. The control unit determines whether the acquired first card information is same as the second card information and the acquired first customer information and the second customer information are same and, if the first card information and the first customer information are the same as the second card information and the second customer information, outputs information for permitting settlement performed using the first card information.

An embodiment is explained with reference to the drawings.

In the embodiment, customer identification for performing personal identification is realized even in cashless settlement in which the personal identification is not performed.

If a customer makes payment by cashless settlement such as credit card settlement, an imaging unit 3 acquires a face image of the customer making the payment. After acquiring the face image, the imaging unit 3 transmits the face image and credit card information to a server 1. A control unit 8 converts the received face image into a numerical value. The control unit 8 in the server 1 determines whether the transmitted credit card information is credit card information transmitted before. If the control unit 8 did not receive the same information as the received credit card information, the control unit 8 stores the numerical value extracted from the face image and the received credit card information in a storing unit 6 in an associated state. If the transmitted credit card information is credit card information stored before, the control unit 8 in the server 1 determines whether the same numerical value as the numerical value extracted from the face image is present among numerical values stored before. If the extracted numerical value is not a numerical value stored before, the control unit 8 stores the extracted numerical value in the storing unit 6 and performs update. After the update, the control unit 8 transmits an identification result. If determining that the numerical values are not the same based on the numerical values stored before, the control unit 8 suspends or stops transaction processing.

An example of a commodity management system for realizing the control explained above is explained below.

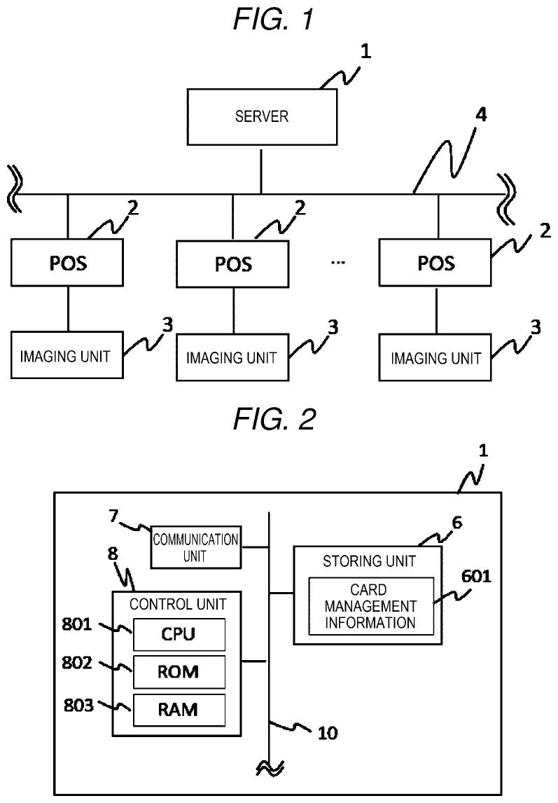

FIG. 1 is a block diagram illustrating a configuration example of an entire customer identification system in this embodiment. The customer identification system includes the server 1, a POS 2, and an imaging unit 3. The server 1 and the POS 2 are connected via a network 4.

The server 1 receives information from and transmits information to devices connected to the server 1. The server 1 receives information transmitted from a POS (Point of sale) or the like connected by radio or wire and stores the received information. The server 1 performs customer identification based on the stored information. The server 1 in this embodiment may be completed in a network constructed in a store or may be not completed in the store and may be connected to a plurality of stores. In this embodiment, customer identification in a network completed in one store is explained as an example. In this embodiment, the server 1 is a server different from a settlement server of an external credit card company (or a settlement agent company) with which the server 1 communicates if settlement processing is performed using a credit card. The server 1 is configured as a server that executes customer identification processing before executing settlement processing.

The POS 2 performs checkout processing. The checkout processing in this embodiment includes processing for reading commodity information from a barcode attached to a commodity that a customer is about to purchase, specifying the commodity information and an amount, and registering the commodity as a purchase target commodity and processing for performing settlement of the registered commodity. A plurality of POSs 2 may be connected on the network 4. A method of the connection may be either wireless or wired.

FIG. 2 is a block diagram illustrating an example of a hardware configuration of the server 1 in the embodiment. The server 1 includes the storing unit 6, a communication unit 7, and the control unit 8. The units are connected through a bus 10.

The storing unit 6 stores information transmitted from the POS 2. The storing unit 6 is configured by a storage medium such as a HDD (Hard Disc Drive) or a flash memory. The storing unit 6 stores card management information 601. As the card management information 601, information of a card for cashless settlement received from the POS 2 and a face image acquired via the imaging unit 3 or a numerical value extracted from the face image are stored in association with each other. The card for cashless settlement in this embodiment includes a card-like medium such as a credit card, a debit card, or a prepaid card. In this embodiment, customer identification at the time of settlement performed using a credit card as the card for cashless settlement is explained as an example. The storing unit 6 stores an operating system, other software such as application programs, and the like necessary for the server 1 to operate as an identification server.

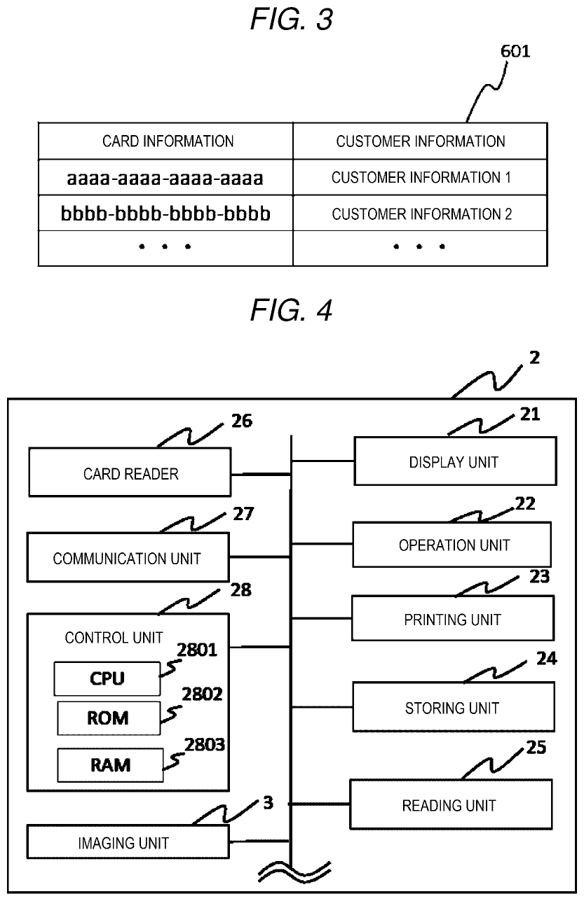

FIG. 3 is a diagram illustrating an example of a data configuration of the card management information 601 stored by the storing unit 6. In the card management information 601, card information and customer information are associated.

The card information is information for specifying a card for cashless settlement used for settlement in the past by the customer and is, for example, a number of a credit card. The customer information is image information representing a face image of the customer acquired via the imaging unit 3. The customer information is acquired by the imaging unit 3 photographing a face image of the customer if the customer performs settlement processing using the card for cashless settlement. The customer information is not limited to the face image and may be information (feature values of a face) such as numerical values of the positions of characteristic parts such as eyes, a nose, and a mouth and the size of a face region extracted from the face image. As a technique for extracting feature values of the face of the customer from the face image, an existing image recognition technique only has to be used. In this embodiment, numerical values (feature values of a face) of the positions of the characteristic parts such as the eyes, the nose, and the mouth and the size of the face region extracted from a region corresponding to the face in the face image are stored as the customer information.

Referring back to FIG. 2, the communication unit 7 is an interface for performing data communication for transmitting and receiving credit card information, a face image, an identification result, and the like according to a predetermined communication protocol to and from the POS 2 connected to a network 10. The communication unit 7 transmits a result of identification performed by the control unit 8. As the communication unit 7, a well-known communication device such as a LAN can be applied.

The control unit 8 includes a CPU (Central Processing Unit) 801, a ROM (Read Only Memory) 802, and a RAM (Random Access Memory) 803. The CPU 801 controls the entire server 1. The ROM 802 stores various programs such as a program used for driving of the CPU 801 and various data. The RAM 803 is used as a work area of the CPU 801. Programs of various kinds of software and various data stored in the ROM 802 and the storing unit 6 are loaded in the RAM 803. The CPU 801 operates according to an information processing program stored in the ROM 802 or the storing unit 6 and loaded in the RAM 803, whereby the control unit 8 executes various kinds of functional processing of the server 1. The control unit 8 converts the positions of characteristic parts such as eyes, a nose, and a mouth and the size of a face region into numerical values from a region corresponding to a face in a received face image and extracts the numerical values as customer information. The control unit 8 performs, via software stored in the storing unit 6, customer identification for comparing the customer information, which is the numerical values extracted from the face image captured by the imaging unit 3, and the customer information stored in the storing unit 6 to determine whether a customer using a specific card for cashless settlement, for example, the same credit card is the same customer. The control unit 8 executes processing for storing the card information and the customer information in the card management information 601 in association with each other and various kinds of processing based on a result of the customer identification.

The bus 10 includes an address bus, a data bus, a control signal line, and the like and transmits data and control signals exchanged among the units connected via the bus 10.

FIG. 4 is a block diagram illustrating an example of the configuration of the entire POS. The POS 2 includes a display unit 21, an operation unit 22, a printing unit 23, a storing unit 24, a reading unit 25, a card reader 26, the imaging unit 3, a communication unit 27, and a control unit 28. The units are connected via a bus.

The display unit 21 is a liquid crystal display or an organic EL (Electro Luminescence) display device. The display unit 21 displays information registered by an operator who operates the POS 2, information relating to checkout processing such as a transaction amount and a change amount, and the like.

The operation unit 22 receives an instruction given to the POS 2 by the operator. The operator operates the POS 2 via the operation unit 22. The operation unit 22 is, for example, input means of a keyboard type. Keys used in commodity registration work and checkout processing such as ten keys, a subtotal button, and a cash total button are provided in the operation unit 22. An operation signal corresponding to key operation is transmitted from the operation unit 22 to the control unit 28. The operation unit 22 may be configured as a touch panel for receiving operation of the operator.

The printing unit 23 is configured by, for example, a thermal printer. The printing unit 23 prints, on a roll-like receipt sheet stored in a POS terminal, for example, information (checkout content) relating to a transaction according to completion of checkout processing with the customer and dispenses the receipt sheet as a receipt.

The storing unit 24 is configured by a storage medium such as a HDD (Hard Disc Drive) or a flash memory. The storing unit 24 stores, for example, software such as an operating system and other application programs necessary for the POS 2 to operate.

The reading unit 25 is a scanner that recognizes, optically or by imaging, a code symbol such as a barcode or a two-dimensional code attached to a commodity or the like. The reading unit 25 decodes the recognized code symbol and reads a commodity code indicated by the code symbol. The control unit 28 of the POS 2 may perform the decoding of the code symbol recognized by the reading unit 25. The reading unit 25 may include a function that can specify a commodity in an object recognition scheme for recognizing the commodity based on feature values of the commodity such as a color and unevenness.

The card reader 26 is a settlement terminal including an IC-chip reading unit and a magnetic reading unit. For example, the card reader 26 reads card information necessary for settlement from a card for cashless settlement. For example, the card reader 26 magnetically reads credit card information necessary for settlement from a credit card. The card reader 26 may be an IC card reader that reads information from an IC card incorporating an IC (Integrated Circuit) chip. The card reader 26 may be configured as an external device configured integrally with the POS 2 and connected to the POS 2 to operate.

The imaging unit 3 acquires biological information of the customer through imaging (a biological-information acquiring unit). The biological information is, for example, a face image. The imaging unit 3 is configured by an imaging device such as a camera. The imaging unit 3 may be integral with the POS 2. The imaging unit 3 may be connected as an external device. Alternatively, the imaging unit 3 may be configured as a separate imaging device connected to the server 1 via the network 4.

The communication unit 27 is an interface for performing transmission and reception of information to and from an external device such as the server 1. The transmitting unit 28 transmits credit card information read by the card reader 26 and a face image to the server 1. The communication unit 27 receives a reply from the server 1.

The control unit 28 includes a CPU (Central Processing Unit) 2801, a ROM (Read Only Memory) 2802, and a RAM (Random Access Memory) 2803. The CPU 2801 controls the entire POS 2. The ROM 2802 stores various programs such as a program used for driving of the CPU 2801 and various data. The RAM 2803 is used as a work area of the CPU 2801. Programs of various kinds of software and various data stored in the ROM 2802 and the storing unit 24 are loaded in the RAM 2803. The CPU 2801 operates according to an information processing program stored in the ROM 2802 or the storing unit 24 and loaded in the RAM 2803, whereby the control unit 28 executes various kinds of functional processing of the POS 2.

An example of checkout processing in this embodiment is explained.

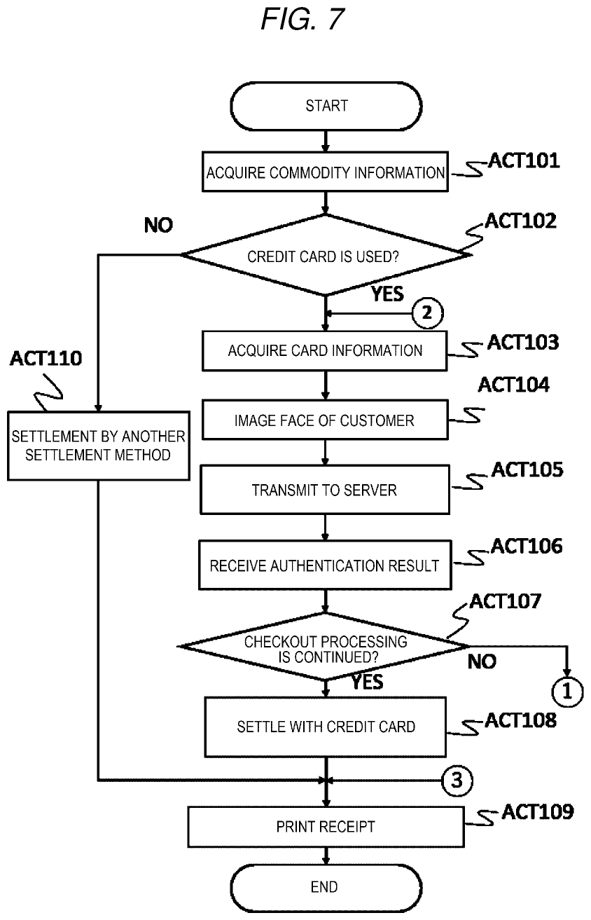

Processing of the customer identification system is explained with reference to FIGS. 7 to 9.

FIG. 7 is a flowchart for explaining a flow of processing by the control unit 28 of the POS 2. The control unit 28 acquires commodity information(ACT101). The control unit 28 recognizes optically or by imaging, via the reading unit 25, a code symbol such as a barcode or a two-dimensional code attached to a commodity and decodes the recognized code symbol to read a commodity code.

The control unit 28 determines whether credit card settlement is performed (ACT 102). The operator inputs a payment method in the checkout processing to the POS 2 via the operation unit 22. The control unit 28 receives an instruction from the operation unit 22 and determines whether content of the instruction is credit card settlement.

If determining based on an input from the operation unit 22 that the payment method is not credit card settlement (NO in ACT 102), the control unit 28 performs the checkout processing without performing acquisition of credit card information by the card reader 26 (ACT 110) and dispenses a receipt (ACT 109). If, for example, payment by cash is performed as a method other than credit card settlement, the operator operates the operation unit 22 to perform settlement processing and dispenses a receipt.

On the other hand, if determining based on the input from the operation unit 22 that the payment method is credit card settlement (YES in ACT 102), the control unit 28 acquires credit card information via the card reader 26 (ACT 103). The control unit 28 reads a credit card with the magnetic reading unit or the IC-chip reading unit included in the credit card reader 26 to thereby acquire credit card information. Subsequently, the control unit 28 acquires a face image via the imaging unit 3 (ACT 104). The control unit 28 images a face of the customer, who is making payment, with a camera connected to the POS 2 to acquire a face image.

The control unit 28 transmits the credit card information acquired via the credit card reader 26 and the captured face image from the communication unit 27 to the server 1 (ACT 105).

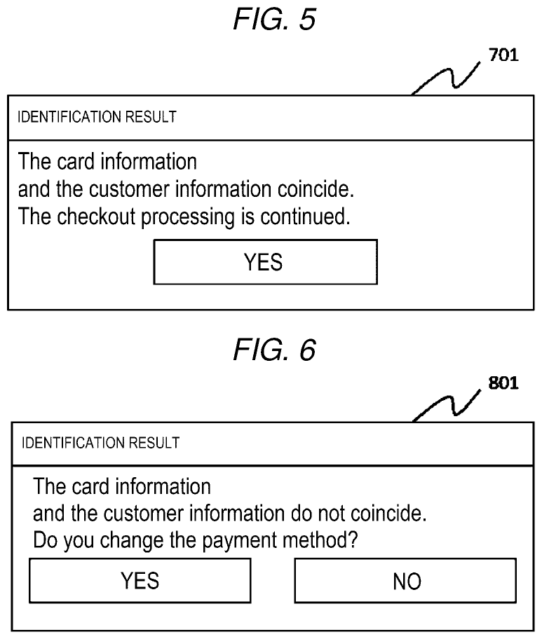

Subsequently, the control unit 28 receives, based on the credit card information and the face image transmitted in ACT 105, information indicating a result of identification processing by the server 1 (ACT 106). The control unit 28 determines based on an identification result received from the server 1 whether to continue the settlement by the credit card (ACT 107). If the received identification result indicates that the credit card information acquired by the card reader 26 is not stored in the card management information 601 of the server 1, that is, if it is determined that the credit card is a credit card used for the first time in the store where the customer identification system is operated, the control unit 28 determines that the checkout processing using the credit card may be executed (YES in ACT 107). Alternatively, if the received identification result indicates that the credit card information acquired by the card reader 26 is stored in the card management information 601 of the server 1 and customer information stored in association with the credit card information and customer information based on the face image of the customer acquired via the imaging unit 3 and transmitted to the server 1 are the same, that is, if it is determined that a customer performed settlement in the past using the credit card and the customer about to perform settlement using the same credit card in the transaction are the same person (YES in ACT 107), the control unit 28 determines that the checkout processing using the credit card may be executed. If determining from the identification result that the checkout processing may be continued, the control unit 28 executes settlement by the credit card (ACT 108). Before executing the checkout processing, the control unit 28 displays, as the identification result, for example, an example illustrated in FIG. 5 on the display unit 21. As an example of a display image displayed if the customer information coincides, the control unit 28 displays an image describing a message “The card information and the customer information coincide. The checkout processing is continued.” like an image 701. The control unit 28 communicates with an external settlement server (not illustrated) and executes the settlement processing based on a transaction amount based on the acquired commodity information and settlement information including the credit card information. Subsequently, the control unit 28 causes the printing unit 23 to dispense a receipt on which information concerning the transaction is described (ACT 109).

On the other hand, if the received identification result indicates that the credit card information acquired by the card reader 26 is stored in the card management information 601 of the server 1 and the customer information stored in association with the credit card information and the customer information based on the face image of the customer acquired via the imaging unit 3 and transmitted to the server 1 in the transaction are not the same, that is, if it is determined that the customer who performed settlement in the past using the credit card and the customer about to perform settlement using the same credit card in the transaction are not the same person (NO in ACT 107), the control unit 28 determines that the use of the credit card is impossible.

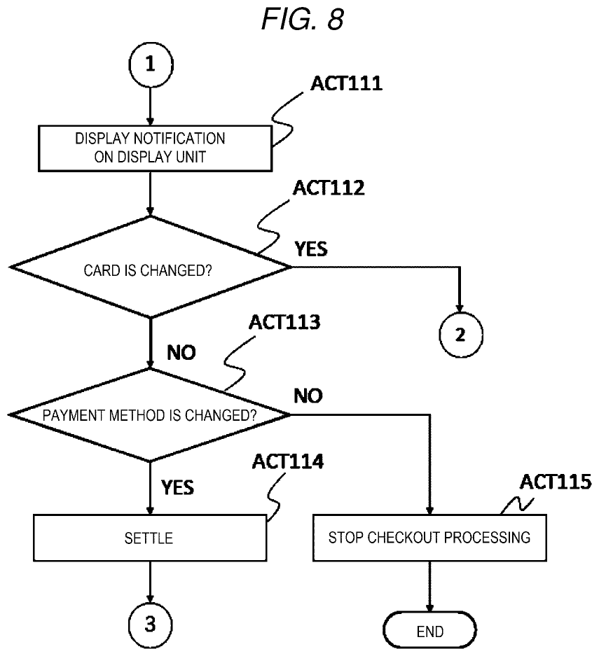

FIG. 8 is a flowchart for explaining the processing of the POS 2 performed if the customer information does not coincide.

The control unit 28 causes the display unit 21 to display an image for notifying that the credit card cannot be used like an image 801 (ACT 111). For example, an example illustrated in FIG. 6 is displayed as the image for notifying that the credit card cannot be used. As an example of a display image displayed if the customer information does not coincide, the control unit 28 displays an image describing a message “The card information and the customer information do not coincide. Do you change the payment method?” like the image 801. Further, the control unit 28 determines whether an instruction to change the payment method to payment by a different credit card is received (ACT 112). If the instruction to change the payment method to payment by a different credit card is received via the operation unit 22 (YES in ACT 112), the control unit 28 returns to ACT 103 and executes the processing explained above.

On the other hand, if the instruction indicating the payment by a different credit card is not received (NO in ACT 112), the control unit 28 determines whether a different payment method is instructed (ACT 113). If a different payment method is instructed or, for example, if settlement by cash or smartphone settlement is instructed (YES in ACT 113), the control unit 28 performs settlement with the instructed payment method (ACT 114). Subsequently, the control unit 28 prints a receipt or the like on which commodity names, prices, a subtotal, a total amount, and the like of commodities read by the reading unit 25 are printed (ACT 109) and ends the checkout processing.

On the other hand, if a different payment method is not instructed, that is, if an instruction to stop the transaction is received (NO in ACT 113), the control unit 28 stops the checkout processing (ACT 115).

Subsequently, processing for storing extracted numerical values (feature values of a face) as customer information is explained.

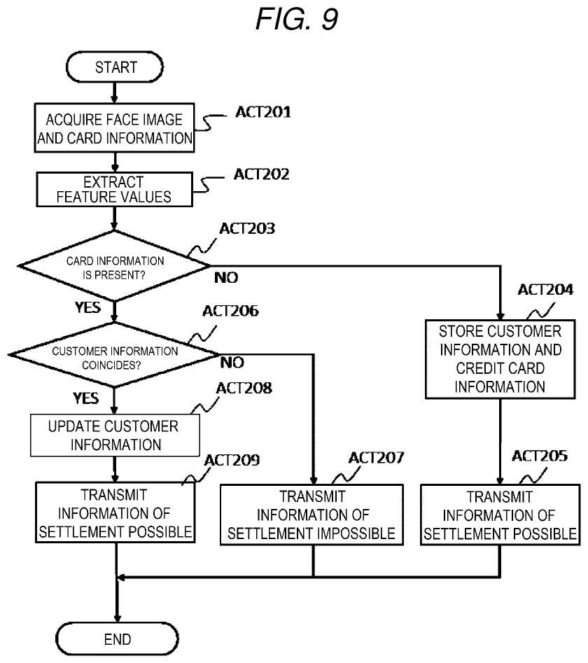

FIG. 9 is a flowchart for explaining a flow of processing by the control unit 8 of the server 1.

The control unit 8 acquires a face image and credit card information (ACT 201). The control unit 8 receives, from the POS 2, via the communication unit 7, credit card information acquired in the POS 2 and a captured face image. Subsequently, the control unit 8 extracts feature values of a face based on the received face image (ACT 202). That is, the control unit 8 extracts features of the face as numerical values from the face image received by the communication unit 7. As an example, the control unit 8 extracts the positions of characteristic parts such as eyes, a nose, and a mouth and the size of a face region as numerical values (feature values of the face) from a region corresponding to the face in the face image (extracted information is hereinafter sometimes simply referred to as feature values of the face or customer information).

The control unit 8 identifies whether the credit card information received (acquired) in ACT 201 is stored in the credit card management information 601 (ACT 203). The control unit 8 identifies based on the received credit card information whether credit card information having the same information is stored in the credit card management information 601 of the storing unit 6. That is, the control unit 8 identifies whether the customer performed settlement in the past with credit card information having the same information as the received credit card information and the credit card information is stored in the credit card management information 601. If the same credit card information as the received credited card information is not stored in the credit card management information 601 (NO in ACT 203), the control unit 8 stores the received credit card information in the credit card management information 601 as a new record and stores the feature values extracted from the face image as customer information in association with the credit card information (ACT 204). After storing the customer information and the credit card information, the control unit 8 transmits an identification result to the POS 2 via the communication unit 7 (ACT 205). That is, the control unit 8 outputs information indicating that the settlement using the received credit card is possible or information for permitting the settlement using the received credit card. The control unit 8 may transmit, for example, information indicating that the credit card information received from the POS 2 is not stored in the card management information 601 or an identification result indicating that the received credit card information is determined as a credit card used for the first time in the store operating the customer identification system.

On the other hand, if the same credit card information as the received credit card information is stored in the credit card management information 601 (YES in ACT 203), the control unit 8 identifies whether the same customer information as the feature values of the face (the customer information) extracted in ACT 202 is stored in the storing unit 6 (ACT 206). That is, the control unit 8 determines whether the customer information stored in association with the credit card information retrieved in ACT 203 and the customer information based on the face image of the customer received from the POS 2 in the transaction are the same. For example, the control unit 8 determines whether the numerical values serving as the customer information stored in the credit card management information 601 in association with the same credit card information as the credit card information acquired from the POS 2 are the same as the numerical values extracted in ACT 202. The control unit 8 is not limited to determining that the customer information is the same if the numerical values are completely the same and may determine whether customer information is the same considering an allowable difference of a range in which the customer can be determined as the same person.

If it is determined that the customer information stored in association with the same credit card information as the credit card information used in the transaction is not the same as the customer information received from the POS 2 (NO in ACT 206), the control unit 8 transmits information indicating that the settlement using the received credit card information is impossible to the POS 2 via the communication unit 7 (ACT 207). For example, the control unit 8 outputs information for prohibiting the settlement using the received credit card information. The control unit 8 may transmit, to the POS 2, an identification result indicating that the customer information stored in association with the same credit card information as the credit card information acquired from the POS 2 and the customer information based on the face image of the customer acquired via the imaging unit 3 and received by the server 1 in the transaction are not the same.

On the other hand, if the same customer information as the acquired customer information is stored in the credit card management information 601 in association with the same credit card information as the acquired credit card information (YES in ACT 206), the control unit 8 performs update of the credit card management information 601 (ACT208). That is, the control unit 8 accesses the credit card management information 601 and updates the customer information stored in association with the same credit card information as the acquired credit card information to customer information extracted anew. The update processing in ACT 208 may not be performed.

The control unit 8 transmits an identification result to the POS 2 via the communication unit 7 (ACT 209). That is, the control unit 8 outputs information indicating that the settlement using the received credit card information is possible or information for permitting the settlement using the received credit card information. The control unit 8 may transmit, to the POS 2, an identification result indicating that the customer information stored in association with the same credit card information as the credit card information acquired from the POS 2 and the customer information based on the face image of the customer acquired via the imaging unit 3 and received by the server 1 in the transaction are the same.

In this embodiment, the customer identification is performed by the method of, if it is determined that the customer who performed settlement in the past using the credit card and the customer about to perform settlement using the same credit card in the transaction are the same person, determining that the checkout processing using the credit card may be executed. However, not only this but it may be determined whether a combination of the received credit card information and the customer information coincides with a combination of the credit card information and the customer information stored in the storing unit 6. For example, the control unit 8 may combine biological information of the customer with credit card information and compare the combination with a combination stored before to authenticate a user of a credit card or the like.

In this embodiment, the feature values of the face are used as the customer information. However, not only this but the face image may be stored in the credit card management information 601 as the customer information and compared, by image recognition, with the face image acquired via the imaging unit 3. In this embodiment, the face image captured by the imaging unit 3 is acquired and the personal identification is performed. However, the imaging unit 3 may acquire an image of a fingerprint, an iris, or the like rather than the face image. In this case, biological information such as the iris may be acquired using a sensor of an optical scheme, a semiconductor scheme, a near infrared transmission scheme, or the like as a biological-information acquiring unit that acquires the biological information as an image. The fingerprint may be acquired by a capacitance scheme or an ultrasound scheme besides the optical scheme.

Information of a member card of a store used by the customer may be added to the customer identification processing in addition to the biological information serving as the customer information. Specifically, if the checkout processing is performed, card information is acquired from the member card of the store presented by the customer using the reading unit 25 or the card reader 26. If member card information is described in a barcode or a two-dimensional code, the barcode or the two-dimensional code is acquired by being imaged by the reading unit 25. If the member card information is described in a magnetic stripe, the member card information is acquired by the magnetic reading unit included in the card reader 26. If the member card information is described in an IC chip, the member card information is acquired by the IC-chip reading unit included in the card reader 26. The member card information is associated with the card information and the customer information in the card management information 601 stored by the storing unit 6 included in the server 1. If performing the customer identification, the control unit 8 also determines whether member card information acquired at a checkout processing time is stored in the card management information 601. In such a configuration, since processing of different customer identification increases if the server 1 performs the customer identification, the server 1 can more accurately perform the customer identification.

### (Modifications of the Embodiment)

The customer identification system may be implemented across a plurality of stores. Specifically, a host server connected by wire or radio from the servers 1 disposed in the stores may be provided and perform processing of customer identification. In this case, the servers 1 transmit face images or credit card information acquired by the POSs 2 of the stores to the host server and transmit an identification result of the host server to the POSs 2. In such a form of implementation, in cashless settlement in which personal identification is not performed, it is possible to perform the personal identification across the plurality of stores.

In this embodiment, the server 1 is explained above as the server different from the settlement server of the external credit card company (or the settlement agent company) with which the server 1 communicates if settlement processing is performed using a credit card. However, not only this, but, for example, an external settlement server may be configured to have the function of the server 1 in this embodiment to execute processing for performing personal identification of a customer before the settlement processing is performed.

In the embodiment, a function of carrying out the invention is recorded in advance in a device. However, not only this, but the function may be downloaded from a network to the device. The function stored in a recording medium may be installed in the device. A form of the recording medium may be any form if the recording medium is a recording medium that can store a program and is readable by the device such as an optical disk. The function obtained by the installing or the download in this way may be a function realized in cooperation with an OS (operating system) or the like in the device.

Several embodiments are explained above. However, the embodiments are presented as examples and are not intended to limit the scope of the invention. These new embodiments can be implemented in other various forms. Various omissions, substitutions, and changes can be made without departing from the spirit of the invention. These embodiments and modifications of the embodiments are included in the scope and the gist of the invention and included in the inventions described in claims and the scope of equivalents of the inventions.

What is claimed is:

1. A customer identification server, comprising:
an acquiring component configured to acquire first customer information based on biological information acquired by a biological-information acquisition component and first card information read by a card reader;
a storing component configured to store second card information and second customer information associated with the second card information; and
a controller configured to determine whether the acquired first card information is same as the second card information and the acquired first customer information and the second customer information are same and, if the first card information and the first customer information are the same as the second card information and the second customer information, output information for permitting settlement performed using the first card information.

2. The customer identification server according to claim 1, wherein the controller determines whether the first customer information and the second customer information are the same and, if the first customer information and the second customer information are not the same, outputs information for prohibiting the settlement performed using the first card information.

3. The customer identification server according to claim 1, wherein, if the first card information acquired via the acquiring component is absent in the storing component, the controller causes the storing component to store the acquired first card information and the first customer information in correlation with each other.

4. The customer identification server according to claim 1, further comprising a second controller configured to perform control for converting first biological information received by a communication component into a numerical value.

5. The customer identification server according to claim 4, wherein a processor comprises the controller and the second controller.

6. The customer identification server according to claim 1, further comprising a facial recognition processing component.

7. The customer identification server according to claim 6, wherein the facial recognition processing component uses characteristics of at least one of eye data, nose data, mouth data, and face size data.

8. A customer identification system, comprising:
a biological-information acquiring component for acquiring biological information of a customer;
an acquiring component for acquiring first customer information based on the biological information acquired by the biological-information acquiring component and first card information read by a card reader;
a storing component for storing second card information and second customer information correlated with the second card information;
a customer identification processing component for determining whether the acquired first card information is same as the second card information and the acquired first customer information is same as the second customer information; and
an output component for, if the first card information and the first customer information are the same as the second card information and the second customer information, outputting information for permitting settlement performed using the first card information.

9. The customer identification system according to claim 8, wherein the controller determines whether the first customer information and the second customer information are the same and, if the first customer information and the second customer information are not the same, outputs information for prohibiting the settlement performed using the first card information.

10. The customer identification system according to claim 8, wherein, if the first card information acquired via the acquiring component is absent in the storing component, the controller causes the storing component to store the acquired first card information and the first customer information in correlation with each other.

11. The customer identification system according to claim 8, further comprising a second controller configured to perform control for converting first biological information received by a communication component into a numerical value.

12. The customer identification system according to claim 11, wherein the biological-information acquiring component and the acquiring component are comprised with a point-of-sale terminal.

13. The customer identification system according to claim 8, further comprising a facial recognition processing component.

14. The customer identification system according to claim 13, wherein the facial recognition processing component uses characteristics of at least one of eye data, nose data, mouth data, and face size data.

15. A customer identification method, comprising:
acquiring biological information of a customer;
acquiring first customer information based on the acquired biological information and first card information read by a card reader;
storing second card information and second customer information correlated with the second card information;
determining whether the acquired first card information is same as the second card information:
determining whether the acquired first customer information is same as the second customer information; and
if the first card information and the first customer information are the same as the second card information and the second customer information, outputting information for permitting settlement performed using the first card information.

16. The customer identification method according to claim 15, further comprising:
determining whether the first customer information and the second customer information are the same and, if the first customer information and the second customer information are not the same, outputting information for prohibiting the settlement performed using the first card information.

17. The customer identification method according to claim 15, further comprising:
if the first card information acquired via the acquiring is absent, storing the acquired first card information and the first customer information in correlation with each other.

18. The customer identification method according to claim 15, further comprising:
converting first biological information received by a communication component into a numerical value.

19. The customer identification method according to claim 15, further comprising:
executing facial recognition processing.

20. The customer identification method according to claim 19, further comprising:
using characteristics of at least one of eye data, nose data, mouth data, and face size data in executing facial recognition processing.
